(19) United States
(12) Patent Application Publication
(10) Pub. No.: US 2022/0318412 A1
(43) Pub. Date: Oct. 6, 2022

(54) PRIVACY-AWARE PRUNING IN MACHINE LEARNING

(71) Applicant: QUALCOMM Incorporated, San Diego, CA (US)

(72) Inventors: Yunhui GUO, San Diego, CA (US); Hossein HOSSEINI, San Diego, CA (US); Christos LOUIZOS, Amsterdam (NL); Joseph Binamira SORIAGA, San Diego, CA (US)

(21) Appl. No.: 17/223,946

(22) Filed: Apr. 6, 2021

(51) Int. Cl. G06F 21/62; G06N 3/08; G06F 17/18

(52) U.S. Cl. CPC G06F 21/62; G06N 3/082; G06F 17/18

(57) ABSTRACT

Certain aspects of the present disclosure provide techniques for improved machine learning using private variational dropout. A set of parameters of a global machine learning model is updated based on a local data set, and the set of parameters is pruned based on pruning criteria. A noise-augmented set of gradients is computed for a subset of parameters remaining after the pruning, based in part on a noise value, and the noise-augmented set of gradients is transmitted to a global model server.

### INTRODUCTION

Aspects of the present disclosure relate to machine learning, and more specifically, to improving data privacy during federated machine learning.

Supervised machine learning is generally the process of producing a trained model (e.g., an artificial neural network), which represents a general fit to a set of training data that is known a priori. Applying the trained model to new data enables production of inferences or predictions, which may be used to gain insights into the new data. For example, the model may be trained to classify input data into defined categories

As the use of machine learning has proliferated for enabling various machine learning (or artificial intelligence) tasks, the need for more efficient and secure communication and handling of machine learning model data has arisen. This machine learning model data may include, for example, data that is used to train the machine learning model and/or to which the machine learning model is applied.

Machine learning algorithms have become a core component for building data analytic systems. Most machine learning algorithms are server-based and thus designed for handling centralized data collection and processing. However, distributed devices such as mobile phones, tablets, mobile sensors, Internet of Things (IoT devices), and other edge processing devices, are generating a huge amount of data each day, enabling various state of the art functionality. To leverage the data generated by such distributed devices, extensive data communication between the distributed devices and a centralized server is necessary, which introduces significant communication costs in addition to creating significant privacy concerns.

Accordingly, systems and methods are needed for enhancing data privacy and reducing communication bandwidth requirements in federated machine learning models.

### BRIEF SUMMARY

Certain aspects provide a method, comprising: updating a set of parameters of a global machine learning model based on a local data set; pruning the set of parameters based on pruning criteria; computing a noise-augmented set of gradients for a subset of parameters remaining after the pruning, based in part on a noise value; and transmitting the noise-augmented set of gradients to a global model server.

Certain aspects provide a method, comprising: receiving a set of parameters trained using private variational dropout; instantiating a machine learning model using the set of parameters; and generating an output by processing input data using the instantiated machine learning model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example system for distributed machine learning using private variational dropout techniques.

FIG. 2 depicts an example workflow for training machine learning models using private variational dropout techniques.

FIG. 3 is an example flow diagram illustrating a method for training machine learning models at a client system using private variational dropout.

FIG. 4 is an example flow diagram illustrating a method for training machine learning models at a central server using private variational dropout.

FIG. 5 is an example flow diagram illustrating a method for inferencing using a machine learning model trained using private variational dropout.

FIG. 6 is an example flow diagram illustrating a method for training machine learning models using private variational dropout.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for intelligently pruning machine learning model parameters during model training. In some aspects, such pruning can enhance data privacy and security as well as reduce communication costs.

Federated learning is generally a process for training a machine learning model, such as a deep neural network, using decentralized client devices (e.g., mobile devices or other processing nodes) and their local client device-specific datasets without explicitly exchanging client data with a centralized server or other client devices. Advantageously, this enables each client device to retain their data locally, reducing security risk and privacy concerns During federated learning, local models (on the distributed client devices) are trained on local datasets and then training-related parameters (e.g. the weights and biases of a deep neural network) are aggregated by a central server to generate a global model that can then be shared among all the distributed client devices. Notably, federated learning differs from conventional distributed learning lies in that in federated learning does not assume that all local datasets across the distributed client devices are the same size and similarly distributed (e.g., independently and identically distributed). Thus, federated learning aims to train machine learning models based on heterogeneous datasets.

The client device local training process aspect of federated learning generally involves computing a set of gradients based on the training data, where the gradients indicate the direction and magnitude of change for one or more of the model parameters. These gradients can be transmitted to the central server. As each client uses its own training data, the gradients returned by each may of course differ. The central repository can then aggregate the gradients in order to refine the central/global model. The process may then be repeated (beginning with each client downloading the refined model parameters to start another training round).

Such repeated transmission of parameters and model updates can place a significant burden on the communications between the client devices and the central server. For example, model training may require a transfer of multiple gigabytes worth of data, which is time-consuming, power intensive, and potentially costly.

Moreover, the large amount of data transmissions increases the possibility for adversarial parties to try to obtain the parameters and/or model update data to reverse engineer the underlying training data.

To resolve the aforementioned issues, aspects described herein employ techniques referred to herein as private variational dropout. This private variational dropout can include selective model or gradient pruning to enhance data security while reducing communication overhead, which in-turn can improve processing efficiency at battery-powered mobile devices, prolong battery life, reduce network traffic, and the like. Notably, the techniques described herein beneficially do not sacrifice model accuracy despite selective pruning.

As used herein, private variational dropout may include learning model parameters and noise variances using local data, pruning a subset of the model gradients based on the learned noise variances, and clipping and adding noise to the model gradients. These pruned, clipped, and noise-augmented gradients are then returned as the model update from the client system. This process enhances data security and reduces communication costs while preserving model accuracy.

Training the noise variances locally allows each client system to identify a subset of the model gradients to be pruned, as discussed below in more detail. This noise variance can also be used during runtime (e.g., when processing new input data using the model to generate an inference). For example, noise may be added to the parameters (e.g., the weights) or to the value computed using the parameter (e.g., to the result of multiplying the weight by an input element, which may be referred to as a pre-activation) based on the corresponding noise variance that was learned for the weight during training.

In addition to this training of noise variants (which can be used to prune parameters), the private variational dropout may also include clipping and adding noise to the gradients during each round of training. Advantageously, the noise added to the gradients may be smaller than the added noise in existing systems, because the aforementioned pruning can itself help increase privacy. That is, because the pruning enhances privacy, smaller amounts of noise can be used while still ensuring data privacy and security, as compared to prior systems.

### Example Federated Learning Machine Architecture

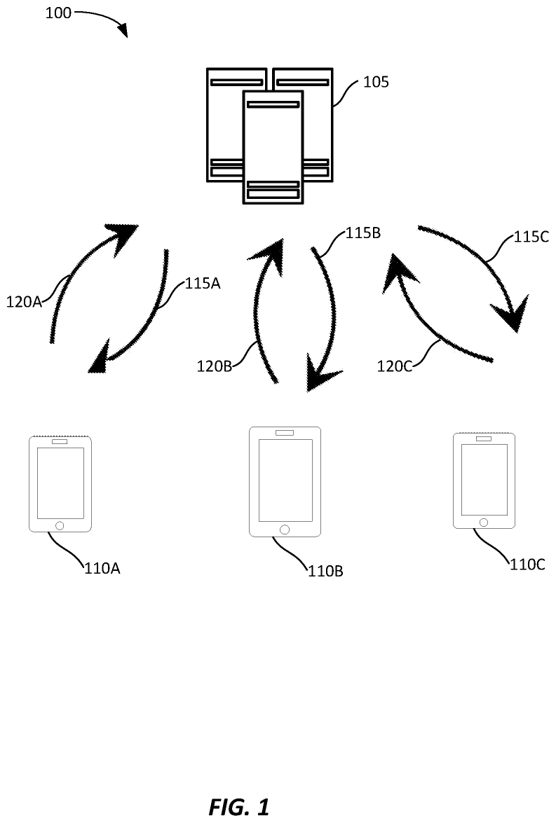

FIG. 1 depicts an example system 100 for federated machine learning using private variational dropout.

As illustrated, the system 100 includes a central server 105, and a set of client devices 110A-C (collectively client devices 110). Although three client devices 110 are depicted, there may generally be any number of client devices participating in the federated learning.

As illustrated, each client device 110 receives a machine learning model from the server 105. This transmission is indicated by arrows 115A-C. In aspects, receiving the model may include, for example, receiving one or more parameters that can be used to instantiate a local copy of the machine learning model. For example, if the model is a neural network, then the model parameters may include a set of weights and biases for the model. In some aspects, each client device 110 also receives relevant hyperparameters or other architecture information, such as the number of layers, the size of each layer, and the like.

Each participating client device 110 can then use the received information to instantiate a local copy of the model. In some aspects, client devices 110 may use this model to perform inferencing on new data. That is, in addition to (or instead of) participating in the training of the model, a client device 110 may simply retrieve the model and use it for inferencing during runtime.

In the illustrated aspect, the client devices 110A-C each use local training data to compute updates for the model. Generally, in a supervised learning system, computing the updates includes processing input training data to generate an output inference or prediction using the model. This output may then be compared against the (known) label for the training data to generate a loss for the data. Based on this loss, gradients can be calculated (e.g., using back propagation) indicating the direction and magnitude of change for one or more of the model parameters.

Variational dropout can generally include adding some level of Gaussian noise to the weights of a model in order to regularize the model. The noise may be defined based in part on a noise variance value. In some aspects, in addition to generating updates for the model parameters, the client devices 110 can also train one or more noise variances for the model, where these noise variances are used during runtime (e.g., when processing new data to generate an inference). That is, during training, the parameters w (e.g., weights), as well as the noise variance a for each such parameter, can be learned and refined based on training data. In at least one aspect, each model parameter is associated with a corresponding noise variance. During inferencing, the learned noise variance(s) can be used to add noise to the parameter(s) or pre-activations.

In aspects, the noise variances are specific to each individual client device 110, and are not shared with the server 105. That is, the received global model may include parameters such as weights, but does not include noise variances. Similarly, the updates returned to the server 105 from each client 110 do not include the learned noise variances. These noise variances can instead be used to perform variational dropout privately at each client 110 as discussed below, thereby acting as a regularizer for the local training.

In some aspects, during the training process, the client device 110 may prune some subset of the parameters and/or gradients based at least in part on the corresponding noise variances. For each round of training, each parameter has a corresponding gradient indicating the direction and magnitude of change for the parameter, as well as a corresponding noise variance (which was also learned or refined during the round of training). In one aspect, the client device 110 may identify and prune one or more gradients or weights that are associated with the highest noise variances, based on a defined pruning criteria. This may be referred to in some aspects as private variational dropout.

Generally, higher values for this pruning criteria result in less dense models (with fewer weights), such that fewer model updates (e.g., fewer gradients) need to be transmitted to the server 105. However, larger values may also reduce the accuracy of the resulting models owing to the more aggressive pruning. In some aspects, therefore, this pruning criteria is a hyperparameter which may be specified by each client device 110 and/or by the central server 105.

In some aspects, the client devices 110 may each also clip the computed gradients and/or apply noise to the computed gradients, prior to returning them to the central server 105. For example, the client devices 110 each clip and add noise to their respective set of gradients based on a clipping value and/or a noise value, respectively. The clipping value and noise value may be configurable hyperparameters. Generally, lower values for the clipping value and higher values for the noise value correspond to reduced model accuracy, but higher data security (because the original values are more obscured or changed). In one aspect, the client devices 110 may use differentially private stochastic gradient descent (DP-SGD) to generate the modified set of gradients based on the clipping and noise values, as discussed in more detail below.

In FIG. 1, these modified gradients are then returned, by each client device 110, to the server 105. The server 105 may then aggregate the gradients and update the global machine learning model based on the aggregate gradients. In aspects, aggregating the gradients may include averaging the gradients provided by each client device 110, computing a weighted average based on weights associated with each client device 110, and the like.

If training is still ongoing, then the server 105 can then transmit the updated model parameters to the participating client devices 110, and another round of training can begin. Alternatively, if training is complete, then the server 105 may provide the trained model to client(s) for use in processing new input data during runtime.

### Example Workflow for Private Variational Dropout

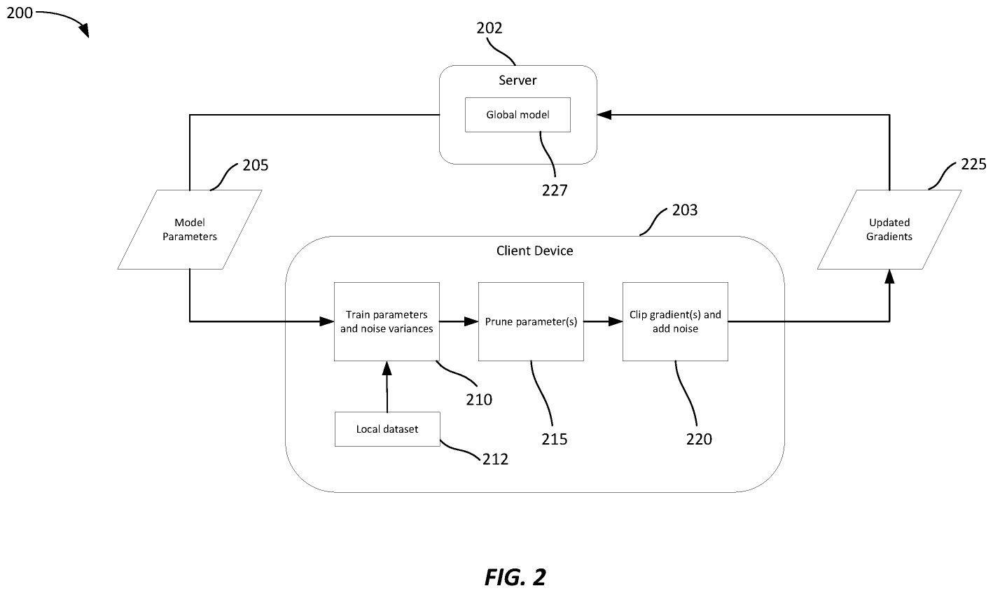

FIG. 2 depicts an example workflow 200 for training machine learning models using private variational dropout techniques. In the illustrated workflow 200, a server 202 transmits model parameters 205 to one or more client devices 203. The model parameters 205 correspond to the global model 227.

As discussed above, these model parameters 205 can generally be used to instantiate a machine learning model. That is, a machine learning model (e.g., a copy of the global model) can be created based on the model parameters 205. For example, if the model is a neural network, then the model parameters 205 may include a set of weights. The client device 203 uses the model parameters 205 to initiate or instantiate a machine learning model. In this way, the server 202 can maintain a global model 227, and each client device 203 can initiate a copy of the model locally.

As illustrated, the client device 203 then performs a model training process. At block 210, the client device 203 trains the parameters and noise variances of the model using a local dataset 212. As discussed above, in some aspects, each trainable parameter (e.g., each weight) is associated with a corresponding trainable noise variance. Training of the parameters and noise variances is generally performed based on loss(es) computed using labeled training data in the local dataset 212.

In some aspects, during runtime, the client device 203 (or another device) can use the noise variances to add noise to the parameters. For example, when processing new input using the model, the client device 203 may add Gaussian noise π˜N(1, α) to each parameter (e.g., to each weight), where N(1, α) is a normal distribution with a mean of one and a variance of α. In some aspects, adding noise to each parameter is performed using multiplicative noise. In other aspects, this noise may be additive.

After the noise variances and parameters are trained, the process continues to block 215, where the client device 203 prunes one or more parameter(s) from the model based on the updated noise variances. For example, the client device 203 may prune r % of the parameters with the highest noise variances (where r is a configurable hyperparameter). That is, the client device 203 may identify the noise variances in the rth percentile, and prune the corresponding parameters. In a related aspect, the client device 203 may prune k parameters with the highest noise variances, where k is also a configurable hyperparameter. In some aspects, the parameters with high noise variances are good candidates for pruning because they are likely less useful or important in the overall model. That is, if a parameter is associated with a high noise variance, the impact of the parameter on the model may be relatively random or unpredictable, indicating that the parameter itself is not important.

If a parameter (e.g., a weight in a neural network) is pruned, then the parameter (e.g., the corresponding edge in a neural network) will not be used during inferencing, and the client device 203 need not transmit any updated value (or any gradient) for this parameter to server 202. Thus, the set of gradients or updates transmitted from the client device 203 to the server 202 is reduced, which beneficially reduces communications costs, latency, power use, and the like.

Once the parameters are pruned, the process continues to block 220, where the client device 203 clips the remaining gradients and adds noise, as discussed below. In aspects, this noise is not based on the noise variance discussed above with respect to the learned noise variances. Instead, it may be defined using a separate noise value, as discussed below. In at least one aspect, the client device 203 does so using differentially private stochastic gradient descent (DP-SGD).

The client device 203 may clip the set gradients based on the norm (or energy) of the gradient of all weights, as opposed to clipping individual gradients. In other words, the clipping seeks to limit the overall energy of the model gradients, rather than each gradient individually. The norm of a vector x (e.g., the set of gradients) may be defined as ∥x∥₂=\sqrt{Σᵢ₌₁ⁿ xᵢ²}. Limiting the norm (or energy) by clipping can ensure that the norm of the gradients is less than or equal to the clipping value C, such that ∥x∥₂≤C. In at least one aspect, the clipping operation is defined using Equation 1 below, where clip(g, C) is the clipping operation, g is the (pruned) gradient tensor, ∥g∥₂ is the norm of the (pruned) gradient tensor, and C is a clipping value.

$$clip ( g , C ) = \frac{g}{max ( 1 , \frac{{‖ g ‖}_{2}}{c} )} \qquad ( 1 )$$

If the norm of the gradient tensor is greater than the clipping value, then the gradient tensor is scaled such that the norm becomes equal to the clipping value. If the norm is equal to or less than the clipping value, then it is not modified. In this way, the client device 203 can clip the gradient tensor using a defined clipping value (which may be a configurable hyperparameter). By performing this clipping, the magnitude of the gradients is restricted, allowing the gradient descent to perform better (particularly when the loss landscape is irregular).

In some aspects, generating the modified set of gradients further includes adding noise to the gradients. For example, the noise may be defined as N(0, Cσ²), which is a normal distribution with a mean of zero and a variance of C times σ², where C is the clipping value, and σ is a noise value. C and σ may be configurable hyperparameters. This noise, added to the gradients during training, can help protect data security of the underlying training data. In some aspects, adding noise to the gradients is performed using additive noise. In other aspects, this noise may be multiplicative.

In one aspect, block 220 is performed by the client device 203 using Equation 2 below, where ĝ is the clipped and noise-augmented set of pruned gradients, Bᵢ is a batch size of batch i, clip(⋅) is the clipping operation, gₓ_{ᵢ} is the (pruned) set of gradients for input data xᵢ in the batch Bᵢ, N(⋅) is a Gaussian distribution, C is the clipping value, and σ is the noise value.

$$\hat{g} = \frac{1}{{B}_{i}} ( {\sum }_{i} clip ( {g}_{{x}_{i}} , C ) + N ( 0 , C {σ}^{2} ) ) \qquad ( 2 )$$

In FIG. 2, the updated gradients ĝ can then be transmitted to the server 202. The server 202 uses the updated gradients 225 to update the global model. In some aspects, if other client devices 203 are participating in the training, then the server 202 can aggregate the updated gradients 225 from each such client device 203 to generate an overall set of updated gradients, which may be used to refine the global model 227.

As indicated in the workflow 200, this process can be repeated (beginning with a new set of model parameters 205 transmitted to each participating client device 203). The training may be repeated for any number of training rounds. Once the training is complete, the server 202 and client device(s) 203 can use the model to generate inferences. Using the techniques described in the present disclose, the model beneficially retains high accuracy while protecting data security and privacy and reducing communication overhead.

### Example Method for Machine Learning Dropout at a Client System Using Private Variational

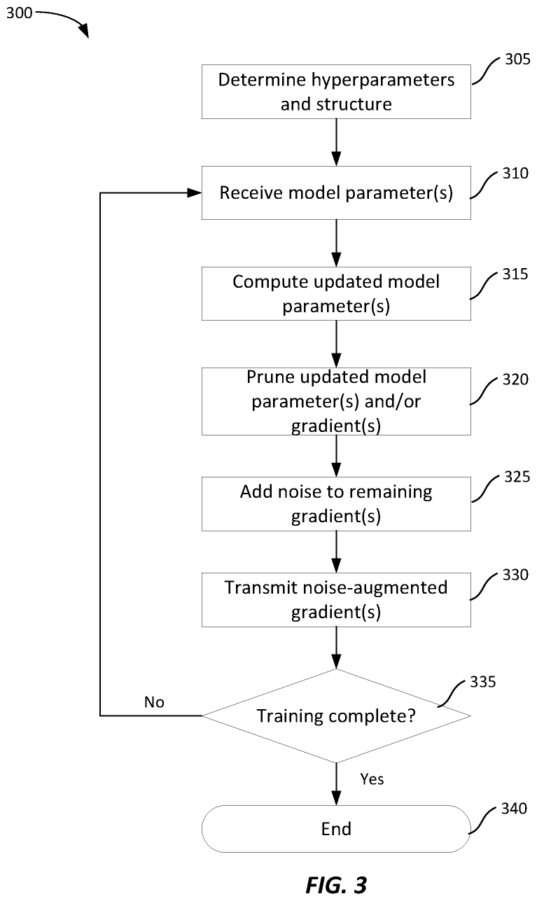

FIG. 3 is an example flow diagram illustrating a method 300 for training machine learning models at a client system using private variational dropout and federated learning.

The method 300 begins at block 305, where the client system determines a set of hyperparameters and model structure for the training process. In some aspects, the client system receives these hyperparameters and structure from a central server managing the distributed learning. In other aspects, each client system can determine the hyperparameters individually. In at least one aspect, some of the hyperparameters may be specified by the central server, while others are configurable by each client system.

Generally, the hyperparameters may include any number and variety of configurable elements affecting the structure of the model and the learning process. For example, for a neural network model, the hyperparameters may include variables such as the learning rate, a dropout rate, and the like. The model structure generally includes the number of layers in the model, the number of elements in each of the layers, the activation function(s) to be used, and the like. In some aspects, the model structure or architecture is specified by the central server, while each client may be allowed to separately select their own training hyperparameters (such as learning rate, dropout rate, and the like), or may elect to use values recommended by the central server.

The method 300 continues to block 310, where the client system receives model parameters. For example, the client system may request and/or receive the parameters from the central server, as depicted in FIGS. 1 and 2. Generally, the model parameters correspond to the most recent version of the machine learning model maintained by the server (or any other coordination entity for federated learning). For example, after each round of federated training, the central server may send an updated global model to the client system at step 310, which then begins the next round of federated training.

The model parameters generally include trainable elements for the model. For example, in the case of a neural network, the model parameters may include values for one or more weights and biases in the model. In some aspects, the received model parameters can also include one or more noise variances. For example, as discussed above, the client system may train not only the weights of a neural network, but also a corresponding noise variance for each weight. This noise variance characterizes the distribution of the random Gaussian noise used or added during runtime.

By using the model parameters and/or hyperparameters, the client system can instantiate a copy of the current global model. In some aspects, instantiating the model may comprise updating a local copy of the model (e.g., retained from a prior training round) using the newly-received model parameters.

At block 315, the client system computes updated model parameters using local training data. In some aspects, this includes updating the model parameters (e.g., weights and biases) and noise variances using variational dropout techniques.

Generally, computing the updated parameters includes generating an output by processing local training data using the copy of the global model at the client system. This output may be compared to a label associated with the local data, such that loss can be computed. This loss can then be used to generate a set of gradients (e.g., via backpropagation), each gradient in the set corresponding to a respective parameter in the set of model parameters.

The gradients each indicate a direction and magnitude of change for each model parameter in order to refine the model. This training process may be performed for each training sample individually (e.g., using stochastic gradient descent), and/or in batches (e.g., using batch gradient descent).

The method 300 then continues to block 320, where the client system prunes one or more of the updated model parameters and/or gradients. In some aspects, the client system determines which parameters and/or gradients to prune based on the corresponding noise variances.

In one such aspect, the client system can prune one or more of the model parameters with high noise variance. For example, the client system may prune the parameters associated with the highest r % of noise variances, where r is a configurable hyperparameter that may be specified by the central server or by the local client system. In other aspects, the client system may prune all parameters associated with a noise variance that is above a defined threshold.

By pruning a given weight, the client system effectively removes the corresponding edge (e.g., a connection between neurons) in the model. Thus, the client system need not transmit any update for this edge, and the corresponding gradient is thereby effectively pruned. This can reduce the bandwidth and other computational resources needed to transmit the model updates to the central system.

Different client system may prune different parameters because each client system trains the noise variances using local (private) data. Generally, to update the global model, the server system can aggregate the updates it receives for each parameter (with the understanding that not all parameters will have updates from all clients).

Note that the model received by a client device at the next round of training may include an edge that was pruned by the client system during the last round. In some aspects, the client system may prune the edge and parameter again before proceeding with the training round. In other aspects, the client system may proceed to update the received model as above (e.g., computing a new update for the previously-pruned parameter, and possibly pruning it again).

After the client system has pruned some portion of the model parameters, the method 300 continues to block 325 where the client system adds noise to the remaining gradients. In some aspects, as discussed above, the client system uses DP-SGD to clip and add noise. For example, the client system may use Equation 2 above to generate a modified set of gradients (also referred to herein as a noise-augmented set of gradients).

By clipping the gradients and by adding such noise, the client system can further preserve the privacy and security of its local training data. In some aspects, the gradient modification process is configurable by each client system. That is, the clipping value and/or noise value may be locally-configured. In another aspect, the central server may specify these values for all client systems.

Advantageously, because the client system first uses the pruning methods described above, the client systems can add a smaller amount of noise to the gradients at each round of pruning, as compared to existing approaches. That is, because the pruning helps to enhance data security, the noise addition can be reduced.

The method 300 then proceeds to block 330, where the client system transmits the modified set of gradients to the central server. That is, the client system transmits the pruned subset of gradients, clipped and/or with added noise, to the central server. As discussed above, the central server may aggregate the gradients received from the set of client systems in order to generate an overall set of aggregated updates. These aggregated gradients may then be used to refine the global model. Subsequently, the updated global model may be distributed (e.g., for the next round of training, or for use in runtime).

At block 335, the client system determines whether the training is complete. This may include, for example, determining whether there are one or more additional rounds of training to be performed (e.g., as indicated or specified by the central server). If training has not completed, then the method 300 returns to block 310. If the training has completed, then the method 300 terminates at block 340.

In some aspects, if training is complete, then the client system can request a final copy of the global model. This model can then be deployed for runtime use by the client system. Additionally, in some aspects, the final model may be received and used by other systems that did not participate in the training. Similarly, the central server may deploy the model for use.

### Example Method for Machine Learning at a Central System Using Private Variational Dropout

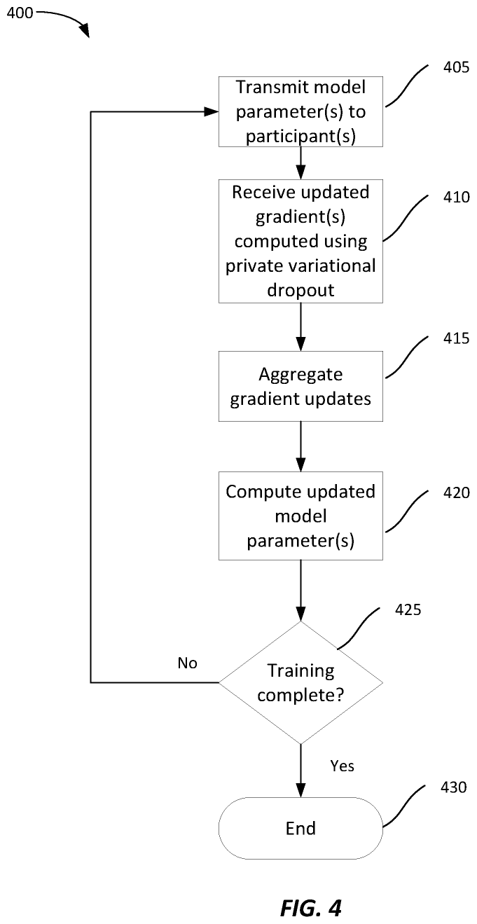

FIG. 4 is a flow diagram illustrating a method 400 for performing federated learning of machine learning models at a central server using private variational dropout, according to some aspects disclosed herein.

The method 400 begins at block 405, where a central server transmits a set of model parameters for a global model to one or more participating client systems. As discussed above, this may include transmitting values for one or more weights, noise variances, or other trainable parameters for the model. Although not included in the illustrated method 400, in some aspects, the central server can also transmit relevant hyperparameters, as discussed above.

At block 410, the central server receives updated gradient(s) from each participating client system. In some cases, these gradients were computed using private variational dropout. As discussed above, this can include pruning parameters based on learned noise variances, as well as clipping and adding noise to the gradients, by each individual client system. This allows the training data to remain private to the client devices, and further reduces the burden on communication when transmitting and receiving the updates between the central sever and the client devices.

The method 400 then continues to block 415, where the central server aggregates the received gradients. In some aspects, as discussed above, each client system may prune some set of the gradients before transmitting them to the central server. In such aspects, therefore, for any given model parameter, the central server may receive updates (e.g., gradients) from less than all of the participating clients.

In some aspects, to aggregate the gradients, the central server can compute, for each model parameter, the average of each received gradient that corresponds to the respective parameter.

At block 420, the central server computes updated model parameters based on the aggregated gradients. This yields an update machine learning model based on the most recent round of training. The method 400 then continues to block 425.

At block 425, the central server determines whether the training is complete. This may include evaluation of any number and type of termination criteria, including a number of completed rounds, a time spent training, performance metrics based on test data, convergence, and the like.

If training is not complete, then the method 400 returns to block 405, where the central server transmits the updated model parameters to each participant. If training is complete, then the method 400 terminates at block 430. The updated model may then be deployed for use by any number and variety of systems, including the central server, the client systems, and systems that did not participate in the training process.

### Example Method for Inferencing Using Machine Learning Models Trained Using Private Variational Dropout

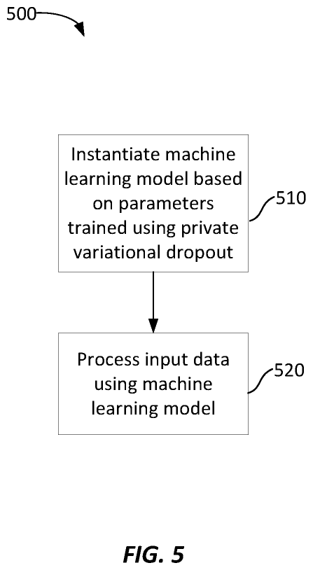

FIG. 5 is an example flow diagram illustrating a method 500 for inferencing using a machine learning model trained using private variational dropout.

The method 500 may be performed using a set of parameters for a machine learning model, where the parameters were generated using private variational dropout, as discussed above. In some aspects, these parameters are received from a central server in a federated learning system. Further, in some aspects, the method 500 is also performed in part based on relevant hyperparameters and model structure needed to instantiate the model (e.g., the variables relating to the architecture and learning of the model), which may also be received from the server.

At block 510, the computing system instantiates a machine learning model based on the received parameters. Advantageously, because the model parameters were trained using private variational dropout techniques discussed herein, the training data used is secure and cannot readily be deciphered by the computing system. Further, using the techniques described herein, the model retains significant accuracy.

Optionally, the computing system can then identify a set of input data. In aspects, identifying the input data may include a wide variety of operations, depending at least partially on the nature of the model. For example, if the machine learning model was trained to classify image data, identifying input data will comprise capturing, receiving, retrieving, or otherwise identifying one or more images to be classified.

At block 520, the computing system processes the identified input data using the initiated machine learning model to generate an appropriate output. In some aspects, processing the input data includes using the model parameter values to modify the input data (or some interim data, such as a feature vector or a tensor) based on the architecture of the network. In some aspects, as discussed above, the computing system may also use the trained noise variances to inject noise into the model. For example, in one aspect, when processing new data using a given connection (with a learned weight), the system may generate and add Gaussian noise with a mean of one and a variance equivalent to the corresponding noise variance learned for the weight. In some aspects, during training with private variational dropout, Gaussian noise can be added to the weights, where the variance of the Gaussian noise (e.g., the noise variance) is learned alongside the weights. At the end of training, the weights with high variances may be pruned and the resultant sparse model can be used for inferencing.

As discussed above, by using the private variational dropout techniques described herein, the machine learning model can retain high accuracy while preserving data security and privacy.

### Example Method for Training Machine Learning Models Trained Using Private Variational Dropout

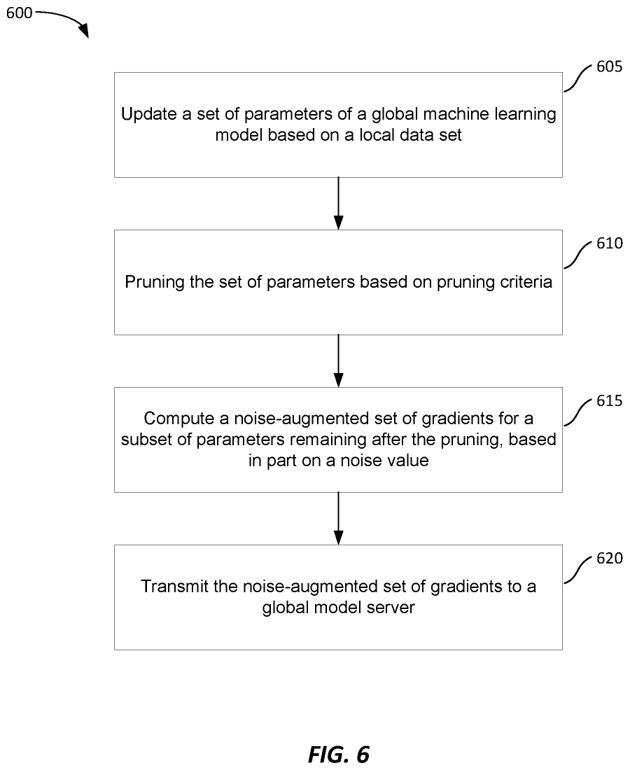

FIG. 6 is a flow diagram illustrating a method 600 for training machine learning models using private variational dropout, according to some aspects disclosed herein.

The method 600 begins at block 605, where a computing system updates a set of parameters of a global machine learning model based on a local data set.

In some aspects, updating the set of parameters comprises using variational dropout to update one or more weights and one or more corresponding noise variances for the machine learning model.

At block 610, the computing system prunes a subset of parameters from the set of parameters, based on pruning criteria.

In some aspects, pruning the set of parameters based on pruning criteria comprises pruning one or more weights from the set of parameters based on the corresponding one or more noise variances.

In some aspects, the pruned one or more weights are identified based on a configurable hyperparameter specifying a percentage of the set of weights to be pruned (e.g., r % as described above).

Further, at block 615, the computing system computes a noise-augmented set of gradients for a subset of parameters remaining after the pruning, based in part on a noise value. In some aspects, this noise value is a hyperparameter (which may be specified locally or by the central server).

In some aspects, computing the noise-augmented set of gradients for the subset of parameters comprises: computing a set of gradients based on the subset of parameters; clipping the set of gradients based on a clipping value; and adding noise to each clipped respective gradient of the set of gradients based on the noise value.

In some aspects, the clipping value and the noise value are configurable hyperparameters of the machine learning model.

In some aspects, clipping the set of gradients comprises: if a norm of the set of gradients exceeds the clipping value, scaling the set of gradients based on the clipping value, and if the norm of the set of gradients does not exceed the clipping value, refraining from changing the set of gradients.

In some aspects, the noise-augmented set of gradients is defined as

$$\hat{g} = \frac{1}{{B}_{i}} ( {\sum }_{i} clip ( {g}_{{x}_{i}} , C ) + N ( 0 , C {σ}^{2} ) )$$

where ĝ is the noise-augmented set of gradients, Bᵢ is a batch size of batch i, clip(⋅) is a clipping operation, gₓ_{ᵢ} is the set of gradients for input batch xᵢ, N(⋅) is a Gaussian distribution, C is the clipping value, and σ² is the noise value.

Additionally, at block 620, the computing system transmits the noise-augmented set of gradients to a global model server.

In some aspects, the method further includes, prior to updating the set of parameters of the machine learning model, receiving the set of parameters from the global model server. In some aspects, the noise-augmented set of gradients is configured to be used by the global model server to update the global machine learning model.

In some aspects, the method further includes receiving, from the global model server, an updated global machine learning model, and updating a set of parameters of the updated central copy of the machine learning model using local data.

### Example Processing System for Private Variational Dropout

In some aspects, the methods and workflows described with respect to FIGS. 2-6 may be performed on one or more devices.

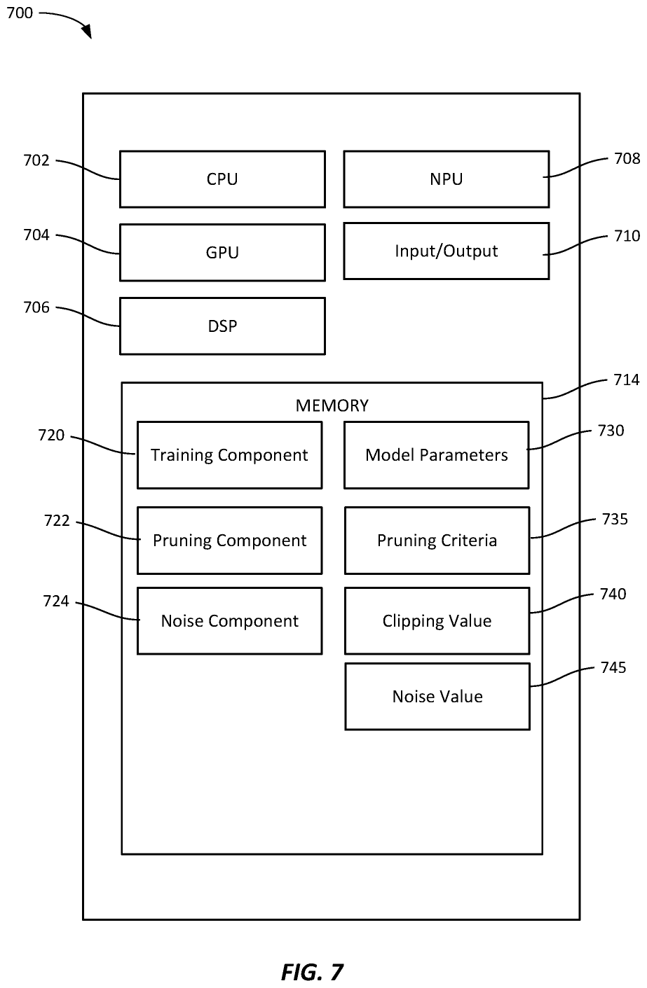

FIG. 7 depicts an example processing system 700 which may be configured to perform aspects of the various methods described herein, including, for example, the methods described with respect to FIGS. 2-3 and 5-6.

Processing system 700 includes a central processing unit (CPU) 702, which in some examples may be a multi-core CPU. Instructions executed at the CPU 702 may be loaded, for example, from a program memory associated with the CPU 702 or may be loaded from a memory 714.

Processing system 700 also includes additional processing components tailored to specific functions, such as a graphics processing unit (GPU) 704, a digital signal processor (DSP) 706, and a neural processing unit (NPU) 708.

Though not depicted in FIG. 7, NPU 708 may be implemented as a part of one or more of CPU 702, GPU 704, and/or DSP 706.

The processing system 700 also includes input/output 710. In some aspects, the input/output 710 can include one or more network interfaces, allowing the processing system 700 to be coupled to a one or more other devices or systems via a network (such as the Internet).

Although not included in the illustrated aspect, the processing system 700 may also include one or more additional input and/or output devices, such as screens, physical buttons, speakers, microphones, and the like.

Processing system 700 also includes memory 714, which is representative of one or more static and/or dynamic memories, such as a dynamic random access memory, a flash-based static memory, and the like. In this example, memory 714 includes computer-executable components, which may be executed by one or more of the aforementioned processors of processing system 700.

In this example, memory 714 includes a training component 720, a pruning component 722, and a noise component 724. The training component 720 may generally be configured to compute gradients and updated model parameters for the model using local data, as discussed above. The pruning component 722 is generally configured to prune some portion of the updated model parameters and/or gradients based on the corresponding noise variances, as discussed above. Further, the noise component 724 may generally be configured to clip and add noise to the resulting set of gradients, such as by using DP-SGD.

The memory 714 also includes a set of model parameters 730, pruning criteria 735, clipping value 740, and noise value 745. As discussed above, the model parameters 730 may correspond to weights and/or noise variances in a neural network. The pruning criteria 735 generally indicate how parameters are pruned (e.g., specifying that the parameters with the top r % of noise variances should be pruned). Generally, the clipping value 740 and noise value 745 control how the noise component 724 clips and adds noise to the gradients, as discussed above.

The depicted components, and others not depicted, may be configured to perform various aspects of the methods described herein.

### Example Clauses

Clause 1: A method, comprising: updating a set of parameters of a global machine learning model based on a local data set; pruning the set of parameters based on pruning criteria; computing a noise-augmented set of gradients for a subset of parameters remaining after the pruning, based in part on a noise value; and transmitting the noise-augmented set of gradients to a global model server.

Clause 2: A method according to Clause 1, further comprising: prior to updating the set of parameters of the global machine learning model, receiving the set of parameters from the global model server, wherein the noise-augmented set of gradients is configured to be used by the global model server to update the global machine learning model.

Clause 3: A method according to any one of Clauses 1-2, further comprising: receiving, from the global model server, an updated global machine learning model; and updating a set of parameters of the updated global machine learning model using local data.

Clause 4: A method according to any one of Clauses 1-3, wherein updating the set of parameters comprises using variational dropout to update one or more weights and one or more corresponding noise variances for the global machine learning model.

Clause 5: A method according to any one of Clauses 1-4, wherein pruning the set of parameters based on pruning criteria comprises pruning one or more weights from the set of parameters based on the corresponding one or more noise variances.

Clause 6: A method according to any one of Clauses 1-5, wherein the pruned one or more weights are identified based on a configurable hyperparameter specifying a percentage of weights in the set of parameters to be pruned.

Clause 7: A method according to any one of Clauses 1-6, wherein computing the noise-augmented set of gradients for the subset of parameters comprises: computing a set of gradients based on the subset of parameters; clipping the set of gradients based on a clipping value; and adding noise to each clipped respective gradient of the set of gradients based on the noise value.

Clause 8: A method according to any one of Clauses 1-7, wherein the clipping value and the noise value are configurable hyperparameters of the global machine learning model.

Clause 9: A method according to any one of Clauses 1-8, wherein clipping the set of gradients comprises: if a norm of the set of gradients exceeds the clipping value, scaling the set of gradients based on the clipping value; and if the norm of the set of gradients does not exceed the clipping value, refraining from changing the set of gradients.

Clause 10: A method according to any one of Clauses 1-9, wherein the noise-augmented set of gradients is defined as

$$\hat{g} = \frac{1}{{B}_{i}} {\sum }_{i} clip ( {g}_{{x}_{i}} , C ) + N ( 0 , C {σ}^{2} ) ) ,$$

where: ĝ is the noise-augmented set of gradients, Bᵢ is a batch size of batch i, clip(⋅) is a clipping operation, gₓ_{ᵢ} is the set of gradients for input batch xᵢ, N(⋅) is a Gaussian distribution, C is the clipping value, and σ² is the noise value.

Clause 11: A method comprising: receiving a set of parameters trained using private variational dropout, wherein the private variational dropout comprises: training the set of parameters and a set of noise variances, pruning the set of parameters based on the noise variances, clipping a set of gradients for the set of parameters based on a clipping value, and adding noise to each clipped respective gradient of the set of gradients based on the noise value; instantiating a machine learning model using the set of parameters; and generating an output by processing input data using the instantiated machine learning model.

Clause 12: A system, comprising: a memory comprising computer-executable instructions; and one or more processors configured to execute the computer-executable instructions and cause the processing system to perform a method in accordance with any one of Clauses 1-11.

Clause 13: A system, comprising means for performing a method in accordance with any one of Clauses 1-11.

Clause 14: A non-transitory computer-readable medium comprising computer-executable instructions that, when executed by one or more processors of a processing system, cause the processing system to perform a method in accordance with any one of Clauses 1-11.

Clause 15: A computer program product embodied on a computer-readable storage medium comprising code for performing a method in accordance with any one of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term “connected to”, in the context of sharing electronic signals and data between the elements described herein, may generally mean in data communication between the respective elements that are connected to each other. In some cases, elements may be directly connected to each other, such as via one or more conductive traces, lines, or other conductive carriers capable of carrying signals and/or data between the respective elements that are directly connected to each other. In other cases, elements may be indirectly connected to each other, such as via one or more data busses or similar shared circuitry and/or integrated circuit elements for communicating signals and data between the respective elements that are indirectly connected to each other.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
updating a set of parameters of a global machine learning model based on a local data set;
pruning the set of parameters based on pruning criteria;
computing a noise-augmented set of gradients for a subset of parameters remaining after the pruning, based in part on a noise value; and
transmitting the noise-augmented set of gradients to a global model server.

2. The method of claim 1, further comprising:
prior to updating the set of parameters of the global machine learning model, receiving the set of parameters from the global model server,
wherein the noise-augmented set of gradients is configured to be used by the global model server to update the global machine learning model.

3. The method of claim 2, the method further comprising:
receiving, from the global model server, an updated global machine learning model; and
updating a set of parameters of the updated global machine learning model using local data.

4. The method of claim 1, wherein updating the set of parameters comprises using variational dropout to update one or more weights and one or more corresponding noise variances for the global machine learning model.

5. The method of claim 4, wherein pruning the set of parameters based on pruning criteria comprises pruning one or more weights from the set of parameters based on the corresponding one or more noise variances.

6. The method of claim 5, wherein the pruned one or more weights are identified based on a configurable hyperparameter specifying a percentage of weights in the set of parameters to be pruned.

7. The method of claim 1, wherein computing the noise-augmented set of gradients for the subset of parameters comprises:
computing a set of gradients based on the subset of parameters;
clipping the set of gradients based on a clipping value; and
adding noise to each clipped respective gradient of the set of gradients based on the noise value.

8. The method of claim 7, wherein the clipping value and the noise value are configurable hyperparameters of the global machine learning model.

9. The method of claim 7, wherein clipping the set of gradients comprises:
if a norm of the set of gradients exceeds the clipping value, scaling the set of gradients based on the clipping value; and
if the norm of the set of gradients does not exceed the clipping value, refraining from changing the set of gradients.

10. The method of claim 7, wherein the noise-augmented set of gradients is defined as
$$\hat{g} = \frac{1}{{B}_{i}} {\sum }_{i} clip ( {g}_{{x}_{i}} , C ) + N ( 0 , C {σ}^{2} ) ) ,$$
where:
ĝ is the noise-augmented set of gradients,
Bᵢ is a batch size of batch i,
clip(⋅) is a clipping operation,
gₓ_{ᵢ} is the set of gradients for input batch xᵢ,
N(⋅) is a Gaussian distribution,
C is the clipping value, and
σ² is the noise value.

11. A non-transitory computer-readable medium comprising computer-executable instructions that, when executed by one or more processors of a processing system, cause the processing system to perform an operation, comprising:
updating a set of parameters of a global machine learning model based on a local data set;
pruning the set of parameters based on pruning criteria;
computing a noise-augmented set of gradients for a subset of parameters remaining after the pruning, based in part on a noise value; and
transmitting the noise-augmented set of gradients to a global model server.

12. The non-transitory computer-readable medium of claim 11, the operation further comprising:
prior to updating the set of parameters of the global machine learning model, receiving the set of parameters from the global model server,
wherein the noise-augmented set of gradients is configured to be used by the global model server to update the global machine learning model.

13. The non-transitory computer-readable medium of claim 12, the operation further comprising:
receiving, from the global model server, an updated global machine learning model; and
updating a set of parameters of the updated global machine learning model using local data.

14. The non-transitory computer-readable medium of claim 11, wherein updating the set of parameters comprises using variational dropout to update one or more weights and one or more corresponding noise variances for the global machine learning model.

15. The non-transitory computer-readable medium of claim 14, wherein pruning the set of parameters based on pruning criteria comprises pruning one or more weights from the set of parameters based on the corresponding one or more noise variances.

16. The non-transitory computer-readable medium of claim 15, wherein the pruned one or more weights are identified based on a configurable hyperparameter specifying a percentage of weights in the set of parameters to be pruned.

17. The non-transitory computer-readable medium of claim 11, wherein computing the noise-augmented set of gradients for the subset of parameters comprises:
computing a set of gradients based on the subset of parameters;
clipping the set of gradients based on a clipping value; and
adding noise to each clipped respective gradient of the set of gradients based on the noise value.

18. The non-transitory computer-readable medium of claim 17, wherein the clipping value and the noise value are configurable hyperparameters of the global machine learning model.

19. The non-transitory computer-readable medium of claim 17, wherein clipping the set of gradients comprises:
if a norm of the set of gradients exceeds the clipping value, scaling the set of gradients based on the clipping value; and
if the norm of the set of gradients does not exceed the clipping value, refraining from changing the set of gradients.

20. The non-transitory computer-readable medium of claim 17, wherein the noise-augmented set of gradients is defined as
$$\hat{g} = \frac{1}{{B}_{i}} {\sum }_{i} clip ( {g}_{{x}_{i}} , C ) + N ( 0 , C {σ}^{2} ) ) ,$$
where:
ĝ is the noise-augmented set of gradients,
Bᵢ is a batch size of batch i,
clip(⋅) is a clipping operation,
gₓ_{ᵢ} is the set of gradients for input batch xᵢ,
N(⋅) is a Gaussian distribution,
C is the clipping value, and
σ² is the noise value.

21. A processing system, comprising:
a memory comprising computer-executable instructions;
one or more processors configured to execute the computer-executable instructions and cause the processing system to perform an operation comprising:
updating a set of parameters of a global machine learning model based on a local data set;
pruning the set of parameters based on pruning criteria;
computing a noise-augmented set of gradients for a subset of parameters remaining after the pruning, based in part on a noise value; and
transmitting the noise-augmented set of gradients to a global model server.

22. The processing system of claim 21, the operation further comprising:
prior to updating the set of parameters of the global machine learning model, receiving the set of parameters from the global model server,
wherein the noise-augmented set of gradients is configured to be used by the global model server to update the global machine learning model.

23. The processing system of claim 22, the operation further comprising:
receiving, from the global model server, an updated global machine learning model; and
updating a set of parameters of the updated global machine learning model using local data.

24. The processing system of claim 21, wherein updating the set of parameters comprises using variational dropout to update one or more weights and one or more corresponding noise variances for the global machine learning model.

25. The processing system of claim 24, wherein pruning the set of parameters based on pruning criteria comprises pruning one or more weights from the set of parameters based on the corresponding one or more noise variances.

26. The processing system of claim 25, wherein the pruned one or more weights are identified based on a configurable hyperparameter specifying a percentage of weights in the set of parameters to be pruned.

27. The processing system of claim 21, wherein computing the noise-augmented set of gradients for the subset of parameters comprises:
computing a set of gradients based on the subset of parameters;
clipping the set of gradients based on a clipping value; and
adding noise to each clipped respective gradient of the set of gradients based on the noise value.

28. The processing system of claim 27, wherein the clipping value and the noise value are configurable hyperparameters of the global machine learning model.

29. The processing system of claim 27, wherein clipping the set of gradients comprises:
if a norm of the set of gradients exceeds the clipping value, scaling the set of gradients based on the clipping value; and
if the norm of the set of gradients does not exceed the clipping value, refraining from changing the set of gradients.

30. A method, comprising:
receiving a set of parameters trained using private variational dropout, wherein the private variational dropout comprises:
training the set of parameters and a set of noise variances,
pruning the set of parameters based on the noise variances,
clipping a set of gradients for the set of parameters based on a clipping value, and
adding noise to each clipped respective gradient of the set of gradients based on the noise value;
instantiating a machine learning model using the set of parameters; and
generating an output by processing input data using the instantiated machine learning model.
